(19) United States
(12) Patent Application Publication
(10) Pub. No.: US 2008/0040818 A1
(43) Pub. Date: Feb. 14, 2008

(54) Storage apparatus, firmware renewal method, and control device

(75) Inventors: Hirotaka Iima, Kawasaki (JP); Hiroshi Tsurumi, Kawasaki (JP); Masaaki Tamura, Kawasaki (JP); Masataka Shitara, Kawasaki (JP)

Correspondence Address: Patrick G. Burns, Esq.;GREER, BURNS & CRAIN, LTD., 300 South Wacker Dr., Suite 2500, Chicago, IL, 60606, US

(73) Assignee: FUJITSU LIMITED

(21) Appl. No.: 11/635,983

(22) Filed: Dec. 8, 2006

(30) Foreign Application Priority Data
Aug. 14, 2006 (JP) 2006-220877

(51) Int. Cl. G06F 11/00

(52) U.S. Cl. 726/36

(57) ABSTRACT

A storage apparatus divides and stores firmware which is drive control software to record and reproduce data in a disk medium into a non-volatile memory and a disk medium, and at the time of activating the apparatus, stores and executes firmware read from the non-volatile memory and the disk medium into a volatile memory. A renewal request processing unit, when received a renewal request of the firmware from a host, advises the host of the renewal completion at a point of time when new firmware transferred from the host is received and stored in the buffer memory. The background renewal unit, after the advice of the renewal completion, writes and renews the new firmware into the non-volatile memory and the disk medium as a background processing using the processing idle time of a command issued by the host.

### BACKGROUND OF THE INVENTION

1. Field of the Invention

The present invention relates to a storage apparatus, a firmware renewal method, and a control device that downloads and renews a firmware which is drive control software to record and reproduce data by a renewal request from a host, and in particular, it relates to a storage apparatus, a firmware renewal method, and a control device that transmits a new firmware from a host in an operating state of the apparatus and renews an old firmware at the apparatus side.

2. Description of the Related Arts

Heretofore, the firmware mounted on a controller of a magnetic disk device as drive control software, even during the operation after the apparatus is shipped to a user, is given counter measures against various factors developed subsequently, so that the firmware is upgraded in version, and is renewed from time to time by downloading the firmware of a new version. Such renewal of the firmware in the magnetic disk device is required to be performed for each one set of the magnetic disk device. For example, in the disk array system connected to the host as a sub-system, the firmware of a new version is transmitted and downloaded to the apparatus side from the host for a large number of magnetic disk devices mounted in the disk array, and the renewal of the firmware is executed within the apparatus. In the conventional magnetic disk device, the firmware is divided and stored into a flush memory which is a non-volatile memory provided within the apparatus and a magnetic disk, and when the apparatus is activated, a boot code stored in a forefront position of the flush memory is executed, and the firmware within the flush memory and the firmware of the magnetic disk medium are read, and are written in the buffer memory which is a volatile memory and SRAM, and are executed by a CPU, and the recording and reproducing of the data for the magnetic disk medium is performed. Such conventional renewal processing of the firmware for the magnetic disk device is performed by the following procedure.
(1) A new firmware of a new version is transferred to the magnetic disk device of the host, and is stored (firmware download) in the buffer memory.
(2) The old firmware of the old version developed in SRAM is overwritten by the new firmware stored in the buffer memory and is changed over to the firmware of the new version.
(3) After the changeover, the portion corresponding to the firmware of the new version is written and renewed in the firmware storage areas of the flush memory and the magnetic disk medium.

(4) The renewal completion is advised to the host, and the connection with the host is separated.

However, in such conventional firmware renewal method, there are the following problems. First, the renewal time of the firmware of the magnetic disk device requires an extremely long time as compared with the command execution time such as an ordinary read command and write command, and a host having performed a renewal request of the firmware must wait until the renewal completion is advised from the magnetic disk device. Hence, during the renewal time, a read command and write command are not executable, and in the disk array system including a large number of magnetic disk devices, the renewal of the firmware becomes a cause of inviting a reduction in the performance of the system. Further, in the magnetic disk device, as the background functions executed conventionally in an idle state waiting for a command, there is a processing internally executed such as a self test and the like. However, this is interrupted during the renewal of the firmware, and the time required for this processing does not becomes a target of the self test and the trouble prediction function, and hence, there is a problem that a periodic quality and functional check does not work.

### SUMMARY OF THE INVENTION

According to the present invention is to provide a storage apparatus, a firmware renewal method, and a control device that makes the execution of a host issuing command and an internally generated command possible even during the renewal of the firmware and does not discontinue inhibition of performance deterioration and a quality and functional check.

### (Apparatus)

The present invention is a storage apparatus, dividing and storing a firmware which is drive control software to record and reproduce data in the storage apparatus into a non-volatile memory and a storage medium, and storing and executing the firmware read from the non-volatile memory and storage medium in the volatile memory at the activating time of the apparatus, characterized by comprising:

a renewal request processing unit that advises a host device of the completion response at the time when a new firmware transmitted from the host device is received and stored in a buffer memory when the renewal request of the firmware is received from the host device; and

a background renewal unit that writes and renews the new firmware in the non-volatile memory and storage medium as a background processing using a processing idle time of the command issued by the host device after the advice of the renewal completion.

Here, the renewal request processing unit overwrites the new firmware stored in the buffer memory on an old firmware developed in the buffer memory and volatile memory, and after the renewal, activates the apparatus to change over to the processing of the new firmware; and advises the host device of the completion response for the renewal request by execution of the new firmware after the changeover.

A background renewal unit overwrites and renews a firmware portion corresponding to the disk medium from among the new firmware stored in the buffer memory and volatile memory on the old firmware portion of the storage medium as a whole, and divides a firmware portion corresponding to the non-volatile memory from among the new firmware stored in the buffer memory and volatile memory into the smallest units writable in the non-volatile memory, and overwrites and renews them in order on the old firmware portion of the non-volatile memory.

The background renewal unit prohibits the control processing in which the generation of an idle time allotted with the renewal processing is inhibited during the renewal processing of the new firmware for the storage medium and the non-volatile memory.

The background renewal unit, when received a command in which the generation of an idle time allotted with the renewal processing is inhibited during the renewal processing of the new firmware for the storage medium and the non-volatile memory, puts the execution of the command into a waiting state until the completion of the renewal processing, and allows the command to be executed when the renewal processing is completed.

The background renewal unit, when received the status command advising the host device of the error or busy and the like during the renewal processing of the new firmware for the storage medium and non-volatile memory, puts the transmission of a status command into a waiting state until the completion of the renewal processing and transmits the status command when the renewal processing is completed.

### (Method)

The present invention is a firmware renewal method of the storage apparatus, dividing and storing the firmware, which is drive control software to record and reproduce data in a storage medium, into a non-volatile memory and the storage medium, and at the activating time of the apparatus, storing and executing the firmware read from the non-volatile memory and storage medium into the volatile memory, characterized by comprising:

a renewal request processing step that advises the host device of the completion response at the time when the new firmware transmitted from the host device is received and stored in the buffer memory when the renewal request of the firmware is received from the host device, and

a background renewal step that writes and renews the new firmware in the non-volatile memory and storage medium as a background processing using a processing idle time of the command issued by the host device after the advice of the renewal completeion.

### (Control Device)

The present invention is a control device of the storage apparatus that divides and stores the firmware, which is a drive control software to record and reproduce data in a storage medium into a non-volatile memory and the storage medium, and at the activating time of the apparatus, stores and executes the firmware read from the non-volatile memory and storage medium into the volatile memory, characterized by comprising:

a renewal request processing unit that advises the host device of the completion response at the time when the new firmware transmitted from the host device is received and stored in the buffer memory when the renewal request of the firmware is received from the host device, and

a background renewal unit that writes and renews the new firmware in the non-volatile memory and storage medium as a background processing using a processing idle time of the command issued by the host device after the advice of the renewal completion.

According to the present invention, when a renewal request command of the firmware is issued from the host device and the new firmware is transferred by a device interface, the new firmware is stored in a buffer memory, and at the stage of changing over to the execution of the new firmware, the host device is advised of the renewal completion, so that the renewal completion can be responded to the renewal request command within a short period of time without waiting the renewal of the firmware in a non-volatile memory and storage medium within the storage apparatus, and similarly to a storage array system, when a large number of storage apparatuses exist under command of the host device, the deterioration of the performance seen from the entire system can be avoided. Further, when the new firmware stored in the buffer memory within the storage apparatus is written and renewed in the nonvolatile memory by the background processing, the new firmware is divided and renewed so that it can be executed in parallel with the background processing of the firmware renewal and the host issuing command and the processing of the internally generated command, and the deterioration of the performance and reliability of the apparatus and the system accompanied with the firmware renewal can be inhibited to the smallest possible level. Further, during the renewal of the firmware performed as the background function, internal processing taking a long time is prohibited, and at the same time, a status command such as a command, error, and busy and the like that hardly cause a problem even if kept waiting is not executed, but is put into a waiting state until the completion of the renewal, so that the firmware renewal performed as the background processing can be processed within a short period of time. The above and other objects, features, and advantages of the present invention will become more apparent from the following detailed description with reference to the drawings.

### BRIEF DESCRIPTION OF THE DRAWINGS

FIG. 1 is a block diagram of a magnetic disk device showing one embodiment of the present invention;

FIG. 2 is a block diagram of a disk array device including the magnetic disk device of the present embodiment;

FIG. 3 is an explanatory drawing showing the storage and read arrangement of firmware at the activating time in the present embodiment;

FIG. 4 is an explanatory drawing of a storage arrangement in which a renewal request is received and an old firmware is changed over to the new firmware and the new firmware is executed;

FIG. 5 is an explanatory drawing of the storage arrangement at the firmware activating time for the disk medium;

FIG. 6 is an explanatory drawing of the storage arrangement at the firmware activating time for a non-volatile memory;

FIG. 7 is an explanatory drawing of the storage arrangement at the firmware renewal completion time;

FIG. 8 is an explanatory drawing of a firmware download processing by the present embodiment; and

FIG. 9 is a flowchart of the control processing including a firmware renewal processing by the present embodiment with an idle loop as a starting point.

### DETAILED DESCRIPTION OF THE PREFERRED EMBODIMENTS

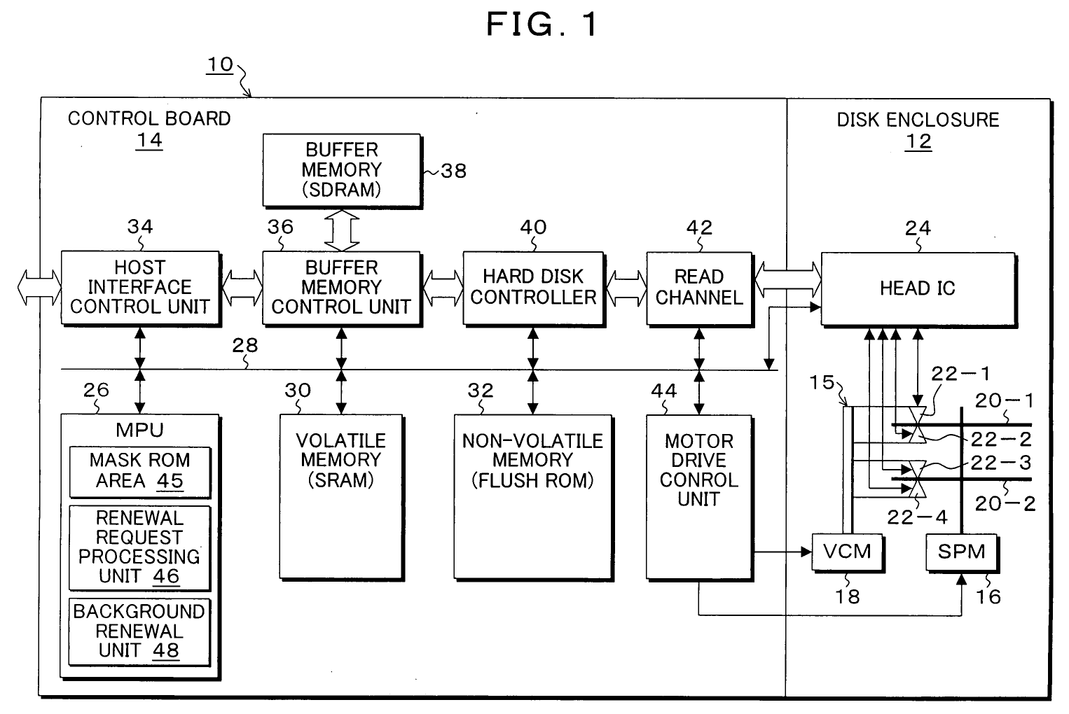

FIG. 1 is a block diagram of a magnetic disk device adapted to the present invention. In FIG. 1, a magnetic disk device 10 known as a hard disk drive (HDD) is configured by a disk enclosure 12 and a control board 14. The disk enclosure 12 is provided with a spindle motor 16, and a rotational axis of the spindle motor 16 is installed with magnetic disks 20-1 and 20-2 as disk mediums, and is rotated for a fixed time, for example, 10000 rpm. Further, the disk enclosure 12 is provided with a voice coil motor 18, and the voice coil motor 18 mounts heads 22-1 to 22-4 on the arm top end of a head actuator, and performs head positioning of the heads for the recording surfaces of the magnetic disks 20-1 and 20-2. The heads 22-1 to 22-4 are integrally mounted with write head elements and read head elements. Further, as magnetic recording system by the heads 22-1 to 22-4 for the magnetic disks 20-1 and 20-2, either of a longitudinal magnetic recording system or a vertical magnetic recording system may be adapted. The heads 22-1 to 22-4 are connected to a head IC 24 by signal lines, and the head IC 24 selects one head by a head select signal based on a write command or a read command from a host which becomes a host device, and performs writing or reading. Further, the head IC 24 is provided with a write driver for a write system, and a pre-amplifier for a read system. A control board 14 is provided with a MPU 26. A bus 28 of the MPU 26 is provided with a volatile memory 30 using a SRAM and the like in which a firmware being drive control software including control codes and variables is developed at the activation time of the apparatus, and a non-volatile memory 32 using a flush ROM and the like in which the firmware developed in the volatile memory 30. Incidentally, in the present embodiment, the firmware is divided and stored into the non-volatile memory 32 and, for example, the magnetic disk 20-1. Further, the bus 28 of the MPU 26 is provided with a host interface control unit 34, a buffer memory control unit 36 that controls a buffer memory 38 using the SDRAM and the like, a hard disk controller 40 to function as a format, a read channel 42 to function as a write modulation unit and a read demodulation unit, and a motor drive control unit 44 that controls the voice coil motor 18 and the spindle motor 16. In the present embodiment, the area of a part of the buffer memory 38 is allotted to a direct access area of the MPU 26, and at the activating time of the apparatus, a part of the firmware read from the non-volatile memory 32 and the magnetic disk 20-1 is written and arranged in the direct access area. The magnetic disk device 10 performs a writing processing and a reading processing based on a command from the host by the execution of the control codes of the firmware. Here, the ordinary operation in the magnetic disk device will be described as follows. When the write command and write data from the host are received by the host interface control unit 34, the write command is decoded by the MPU 26, and the received write data is stored in the buffer memory 38 according to needs, and after that, the data is converted into a predetermined format by the hard disk controller 40, and at the same time, it is added with an ECC code by an ECC coding processing. Then, the data is subjected to scramble, RLL code conversion, and moreover, write compensation by a write modulation system in a read channel 42, and after that, it is written in the disk medium 20-1 from the write head of the head 22-1, for example, selected through the head IC 24 from a write amplifier. At this time, a head positioning signal is given to the motor drive control unit 44 using a DSP and the like from the MPU 26, and the head is allowed to seek after a target track indicated by a command by the voice coil motor 18, and after that, the head is put on drag, whereby a track follow-up control is performed. On the other hand, when the read command from the host is received from the host interface control unit 34, the read command is decoded by the MPU 26, and a read signal read from the read head selected by the head select of the head IC 24 is amplified by the pre-amplifier, and after that, it is inputted to a read demodulation system of the read channel 24, and read data is demodulated by partial response maximum likelihood (PRML) detection and the like, and the ECC demodulation processing is performed by the hard disk controller 40 so as to correct an error, and after that, it is buffered in the buffer memory 38, and the read data is transferred to the host from the host interface control unit 34.

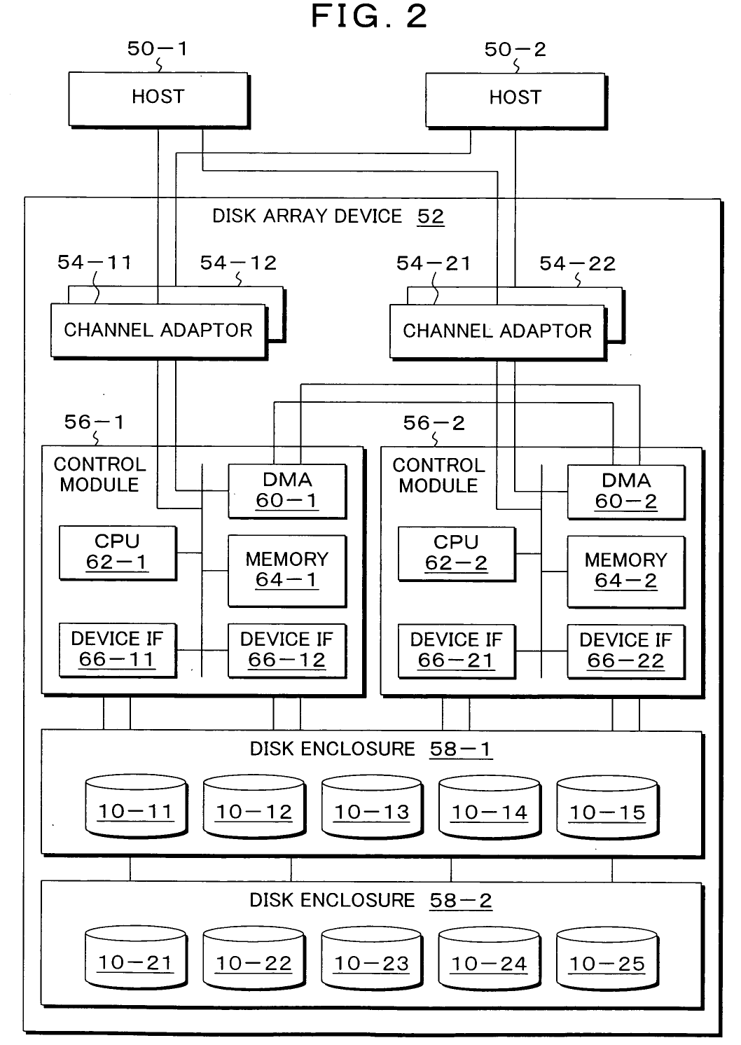

FIG. 2 is a block diagram of the disk array device provided with a plurality of magnetic disk devices of the present embodiment. In FIG. 2, the disk array device 52 is provided with channel adaptors 54-11 and 54-12 and channel adaptors 54-21 and 54-22, which are divided into two systems, and connected to hosts 50-1 and 50-2 such as servers and the like. Further, the disk array device 52 is provided with duplexed control modules 56-1 and 56-2. The control modules 56-1 and 56-2 are provided with disk enclosures 58-1 and 58-2, and each of the disk enclosures is provided with the magnetic disk devices 10-11 to 10-15 and 10-21 to 10-25, respectively, which are the same as those shown in FIG. 1. The magnetic disk devices 10-11 to 10-15 and 10-21 to 10-25 of five sets each of the disk enclosures 58-1 and 58-2 configure a disk array by a predetermined RAID level, for example, a RAID configuration such as RAID 1 or RAID 5. The control modules 56-1 and 56-2 are provided with CPU 62-1 and 62-2, DMA controllers 60-1 and 60-2, memories 64-1 and 64-2, and device interfaces 66-11 and 66-12, and 66-21 and 66-22. The disk array device 52 executes read processing and write processing for the magnetic disk devices 10-11 to 10-15, 10-21 to 10-25 provided in the disk enclosures 58-1 and 58-2 according to the input output requests from the hosts 50-1 and 50-2.

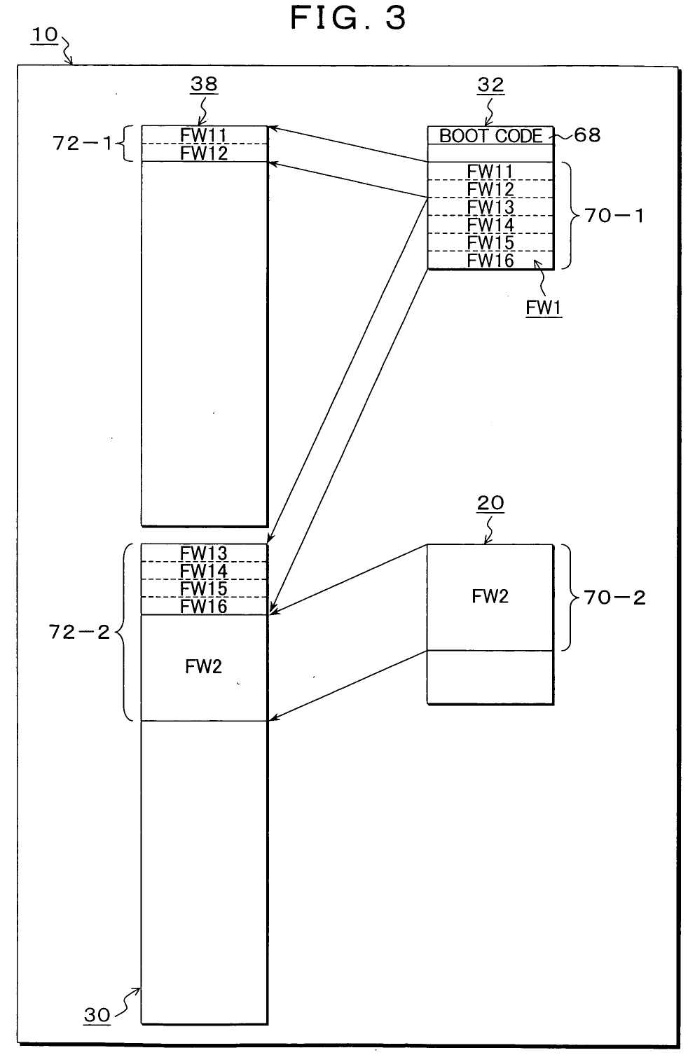

FIG. 3 is an explanatory drawing showing the storage and a read-out arrangement of firm arrangement at the activating time of the apparatus in the embodiment of FIG. 1, and takes out and shows the non-volatile memory 32, magnetic disk 20-1, buffer memory 38, and volatile memory 30 in the embodiment of FIG. 1. The non-volatile memory 32 is a flush ROM, and stores an apparatus activating boot code 68 in the forefront area, and then, it is provided with a firmware area 70-1 having a predetermined size, and stores firmware FW1 in the firmware area 70-1. When the firmware FW1 stored in the firmware area 70-1 uses a flush ROM as the non-volatile memory 32, since an erase and a write for data rewrite are performed, for example, in the smallest unit of 256 KW, the firmware area 70-1 is divided, for example, into six areas shown by broken lines, and the divided portion of the firmware FW1 stored in each area is represented as firmware FW1 to FW16. The firmware area 70-2 of the magnetic disk 20-1 stores FW2. The firmware of the present embodiment, as shown in FIG. 3, is the firmware combining the firmware FW1 stored in the firmware area 70-1 of the non-volatile memory 32 and the firmware FW2 stored in the firmware area 70-2 of the magnetic disk 20-1. Upon powering up the magnetic disk device of the present embodiment, diagnosis and initialization of the device is performed by a MaskROM code stored in a MaskROM area 45 within the MPU 26, and the non-volatile memory 32 is also applied with diagnosis and initialization, and when the diagnosis result is normal, based on the execution of the boot code 68, the firmware FW1 and FW2 are read and arranged at the buffer memory 38 and the volatile memory 30 side and executed. In the present embodiment, in order to write and arrange all the firmware FW1 and FW2 read from the non-volatile memory 32 and the magnetic disk 20-1 in the volatile memory 30 which configures the direct access area of the MPU 26, the capacity runs short, and therefore, a direct access area 72-1 of the MPU 26 is secured in a part of the buffer memory 38, and in this part, a part of the firmware FW1 and FW2 read from the non-volatile memory 32 and the magnetic disk 20-1 is written and arranged. The firmware FW1 and FW2 stored in the non-volatile memory 32 and the magnetic disk medium 20-1 are configured by control codes and variables configuring the drive control software of the magnetic disk device 10 of FIG. 1, and the control codes are control codes and variables that control each of the host interface control unit 32, buffer memory control unit 36, hard disk controller 40, read channel 42, motor drive control unit 44, and head IC 24 of FIG. 1. With respect to the firmware FW1 and FW2, in the case of FIG. 3, firmware FW11 and FW12 of a part of the firmware FW1 are read and written in the direct access area 72-1 of the buffer memory 38, and firmware FW13 to FW16 of a part of the firmware FW1 and the firmware FW2 of the magnetic disk 20-1 are read and written in the firmware area 72-2 of the volatile memory 30. In FIG. 3, though the arrangement of the firmware FW1 and FW2 for the buffer memory 38 and the volatile memory 30 is shown by a simple area division for ease of explanation, the actual arrangement of the firmware FW1 and FW2 for the buffer memory 38 and the volatile memory 30 arranges control codes required to make the processing time short and variables of high frequency in order to secure the processing performance in the firmware area 72-2 of the volatile memory 30, and on the other hand, in the direct access area 72-1 of the buffer memory 38, test codes, self-test codes, variables low in reference frequency, and data and the like not directly associated with performance securement are arranged.

As shown in FIG. 3, during the execution of the firmware FW1 and the firmware FW2 composed of the firmware FW11 to FW16 read and arranged in the buffer memory 38 and the volatile memory 30, the MPU 26 of FIG. 1, upon receipt of the firmware renewal request from the host side, executes the firmware renewal processing based on this firmware renewal request. In order to execute such firmware renewal processing, the MPU 26 is provided with the functions realized by the programs of the renewal request processing unit 46 and the background renewal unit 48. The renewal request processing unit 46, upon receipt of the renewal request of the firmware from the host, receives a new firmware transferred from the host and stores it in the buffer memory 38, and advises the host of the completion response at a point of time when the new firmware is stored in the buffer memory 38. More to be specific, the renewal request processing unit 46 stores the new firmware received from the host through the host interface control unit 34 in the buffer memory 38, and then, sets a renewal completion request flag after the replacement by the new firmware, and re-starts the apparatus (re-boots by the power-on start processing). By the boot code 68, as shown in FIG. 3, the old firmware arranged in the buffer memory 38 and the volatile memory 30 are overwritten and renewed by the new firmware, and the execution of the old firmware is changed over to the new firmware, and the host is advised of the renewal completion for the renewal request by the new firmware (according to the renewal completion request flag) after the changeover. Hence, in the present embodiment, in a state in which the new firmware is downloaded from the host and is overwritten on the old firmware on the buffer with the execution changed over to the new firmware, the host can be advised of the renewal completion, and before the original renewal to write the renewed new firmware into the magnetic disk 20-1 and the non-volatile memory 32 and overwrite it on the old firmware is internally performed, the host can be advised of the renewal completion. Hence, as shown in FIG. 2, when the read processing and the write processing are performed for a plurality of magnetic disk devices 10-11 to 15 and 10-21 to 25 provided in the disk enclosures 58-1 and 58-2 for the input output requests of the hosts 50-1 and 50-2, the control module 56-1 of the disk array device 52 issues the firmware renewal requests in order for the magnetic disk devices 10-11 to 15 and 10-21 to 25 of the disk enclosures 58-1 and 58-2 as a substantial host for the firmware renewal requests from the host sides, and perform the renewal processing, so that the renewal completion advice can be obtained in this case -without waiting for the internal firmware renewal in the magnetic disk devices 10-11 to 10-25, thereby making it possible to shorten a binding time for the renewal processing in the control module 56-1 of the disk array device 52. As a result, the lowering of the access performance at the firmware renewal time in the disk array device 52 can be inhibited to the minimum. Needless to mention, even by observing the input output processing performance seen from the hosts 50-1 and 50-2 as the host device for the disk array device 52, the lowering of performance by the firmware renewal can be inhibited to the minimum. Again, referring to FIG. 1, the background renewal unit 48 provided in the MPU 26 writes and renews the new firmware rewritten on the buffer memory 38 and the volatile memory 30 in the non-volatile memory 32 and the magnetic disk 20-1 after the advice of the renewal completion for the host side by the renewal request processing unit 46 as the background processing using a processing idle time of the command issued by the host. With respect to the renewal by this background renewal unit 48, the portions of the corresponding new firmware are collectively written in the magnetic disk 20-1, while with respect to the writing of the new firmware in the non-volatile memory 32, the new firmware is divided into the smallest access units and is correspondingly written in order in the divided portions of the corresponding old firmware. By this dividing write in the non-volatile memory 32 of the new firmware, the read command and the write command during the renewal of the firmware are made executable, and the performance deterioration of the magnetic disk device 10 can be inhibited to the minimum by the renewal processing by the background renewal unit 48. Further, the background renewal unit 48 is allowed to perform the processing to interrupt the renewal processing executed as the background processing, the command execution, the command transmission, and the like or wait the completion of the renewal. In the background renewal unit 48, as the internal processing to be prohibited during the firmware renewal processing, there is a processing which takes a time until the completion such as, for example, a sequential hardware processing. Further, when a command such as interrupting the renewal processing by the background renewal unit 48 is generated, the executing of this command is kept waiting until the renewal processing is completed. As such a command interrupting the renewal processing, the command which takes a time in processing such as an access command, a user information read command, a buffer write command, and the like is included. Further, in the background renewal unit 48, when a status request command such as an error, busy, and the like is received from the host during the background renewal, the execution of the status request command is kept waiting until the completion of the background renewal processing, and an error status or a busy status is responded upon completion of the renewal.

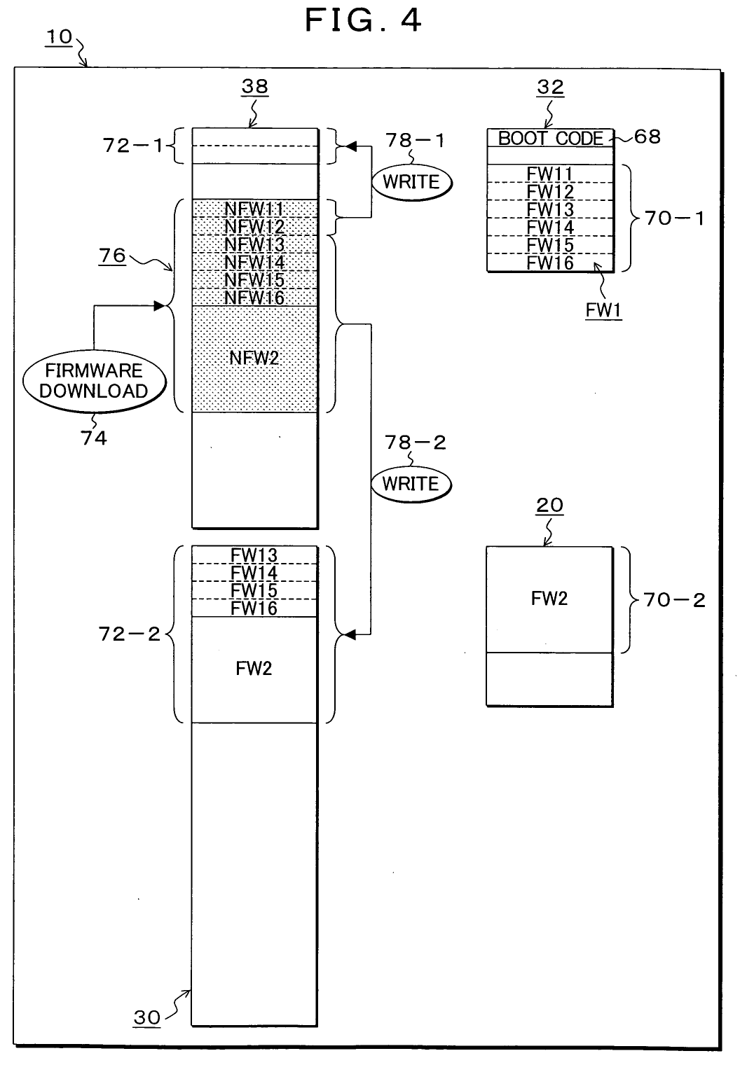

FIG. 4 is an explanatory drawing of a buffer reception processing upon receipt of the renewal request from the host by the renewal request processing unit 46 provided in the MPU 26 of FIG. 1 and a storage arrangement when the old firmware is subsequently changed over to the new firmware and the new firmware is executed.

In FIG. 1, when the firmware renewal request command is received in the host interface control unit 34 from the host, the new firmware is received from the host through the interface processing that establishes the connection of the device interface, and as shown in the buffer memory 38 of FIG. 4, new firmware NFW1 and NFW2 received by the firmware download 74 are stored in an appropriate firmware buffer area 76. Incidentally, for convenience of explanation, the new firmware is divided into two of the NFW1 and NFW2, and moreover, the new firmware NFW1 is shown by being divided into six new firmware NFW11 to NFW16 according to the accessible minimum unit of the non-volatile memory 32. However, in reality, they are one firmware. When the new firmware NFW1 and NFW2 are stored in the buffer memory 38, the legality thereof are confirmed by check sum of the new firmware NFW1 and NFW2. Next, an internal flag required for the control of the background renewal processing unit 48 is set, and after that, the write processings 78-1 and 78-2 are executed and renewed, which overwrite the new firmware NFW11 to NFW16 and NFW2 on the old firmware FW11 to FW16 and FW2 which are now arranged and executed in the direct access area 72-1 of the buffer memory 38 and the firmware area 72-2 of the volatile memory 30. Subsequently, by performing the reboot by activating the apparatus, the execution of the renewed new firmware NFWL1 to NFW16 and NFW2 is started in the direct access area 72-1 of the memory and the firmware area 72-2 of the volatile memory 30. The advise of the firmware renewal completion to the host is performed by the execution of the new firmware renewed on the buffer memory 38 and the volatile memory 30.

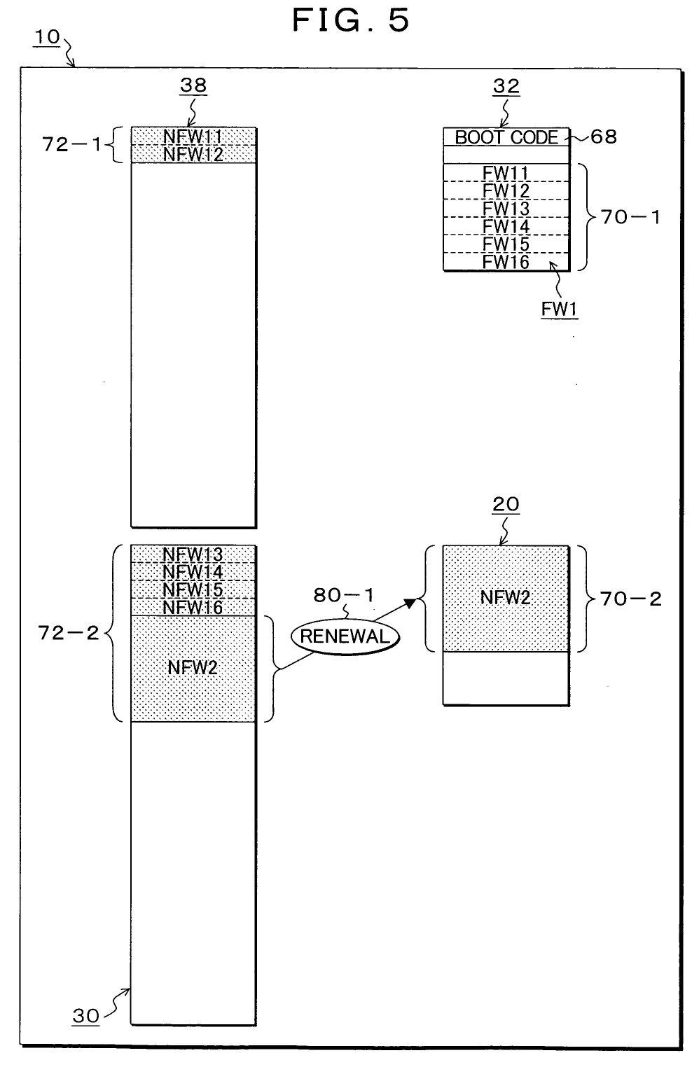

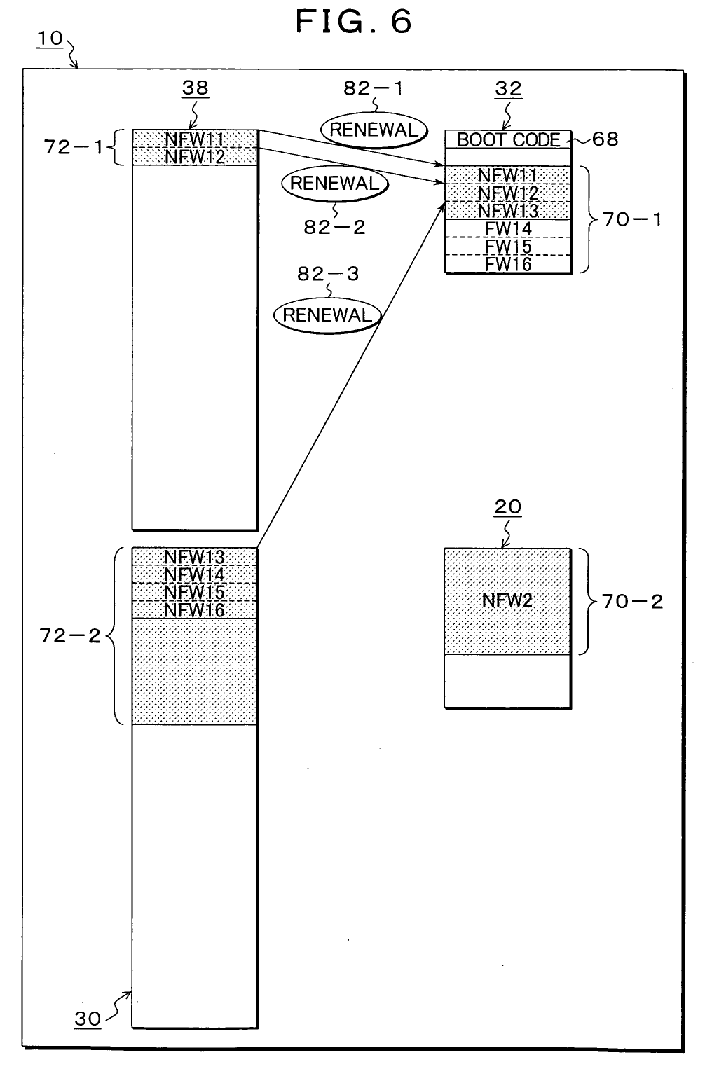

FIG. 5 is an explanatory drawing of the storage arrangement at the firmware renewal time performed as the background processing after the completion advice of the firmware renewal processing to the host by the background renewal unit 48 provided in the MPU 26 of FIG. 1. In FIG. 5, with respect to the renewal of the new firmware NFW11 to NFW16 and NFW2 renewed on the buffer memory 38 and volatile memory 30, first, a renewal processing 80-1 to collectively write the new firmware NFW2 arranged in the volatile memory 30 side into the firmware area 70-2 of the magnetic disk 20-1 is performed. Subsequently, as shown in FIG. 6, renewal processings 82-1, 82-2, 82-3 . . . are performed, in which the new firmware arranged in the buffer memory 38 and the volatile memory 30 sides, that is, each of the new firmware NFW11 to NFE16 which are the divided firmware of the NFW1 is written in order in the firmware area 70-1 of the non-volatile memory 32 as shown in the smallest access unit of the divided new firmware NFW11, NFW12, NFW13 . . . at a timing of idle time of the execution of the command from the host. In such a renewal processing of the non-volatile memory 32 by the divided firmware, if the read command or write command from the host is stored in a command queue and waiting for the execution every time one cycle of the renewal is completed, the read command or the write command stored in the command queue is taken out-from the command queue, and is executed upon completion of the renewal of the divided new firmware. Hence, the processing of the access commands from the host stored in the command queue are not kept waiting until all the renewals of the new firmware for the non-volatile memory 38, and the renewal processing of the new firmware and the parallel execution of the access commands of the host device are made possible, so that the performance deterioration of the system at the host side during the firmware renewal can be inhibited to the minimum. Further, during division and renewal of the new firmware for the non-volatile memory 32, with respect to a command taking time in processing such as a sequential hardware processing such as interrupting the firmware renewal processing, a sequential command, a user information read command, a buffer write command and the like in addition to a status request command requesting for the response from the host such as an error, busy and the like, the processing is prohibited during the renewal of the background processing, and with respect to the commands, the commands are kept waiting and the processing thereof are performed after the renewal completion, so that the background processing of the firmware is prevented from being inhibited more than necessary by the access command from the host, and both the inhibition of the deterioration of the processing performance during the firmware renewal and the shortening of the processing time of the renewal processing can be made compatible.

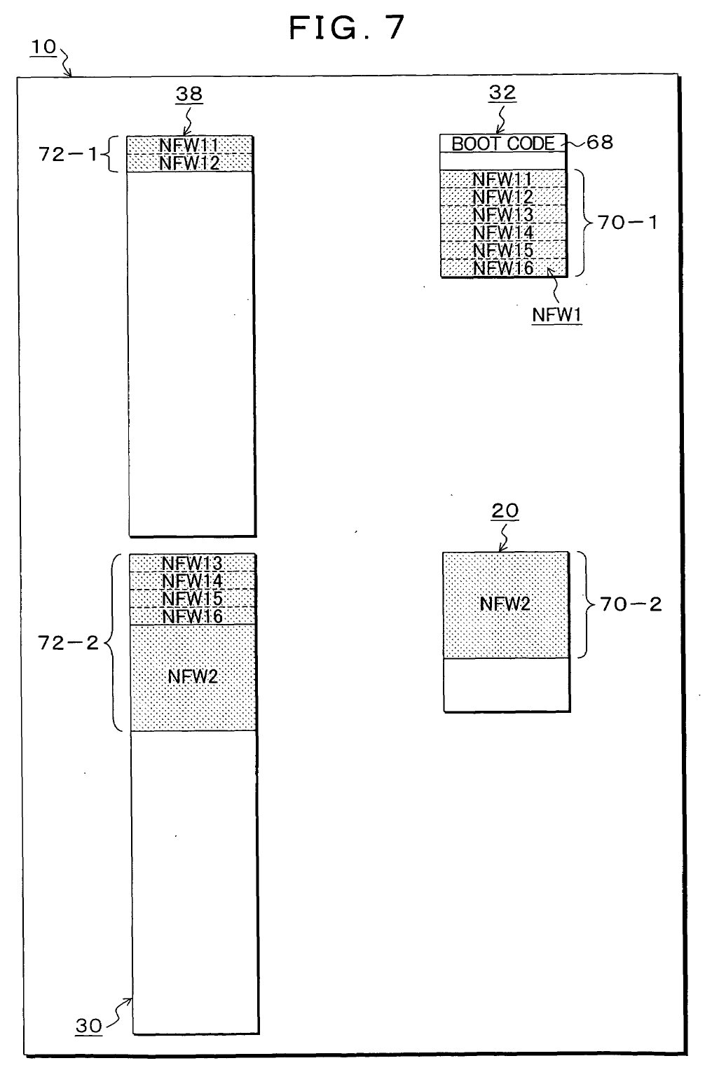

FIG. 7 is an explanatory drawing of the storage arrangement at the firmware renewal completion time, where the firmware arranged in the buffer memory 38 and the volatile memory 30 become the new firmware NFW11 to NFW16 and NFW2 after renewal, and the firmware stored in the non-volatile memory 32 and the magnetic disk 20-1 become the renewed new firmware NFW11 to NFW16 and NFW2. Consequently, after that until the magnetic disk device is turned off from the power source, the control of the magnetic disk device is performed by the new firmware arranged in the buffer memory 38 and the volatile memory 30, and at the reactivating time after the power source of the magnetic disk device is cut off, similarly as shown in FIG. 3, by the execution of the boot code 68 of the non-volatile memory 32, the renewed new firmware is read and arranged into the buffer memory 38 and the volatile memory 30 from the non-volatile memory 32 and the magnetic disk 20-1, and is executed.

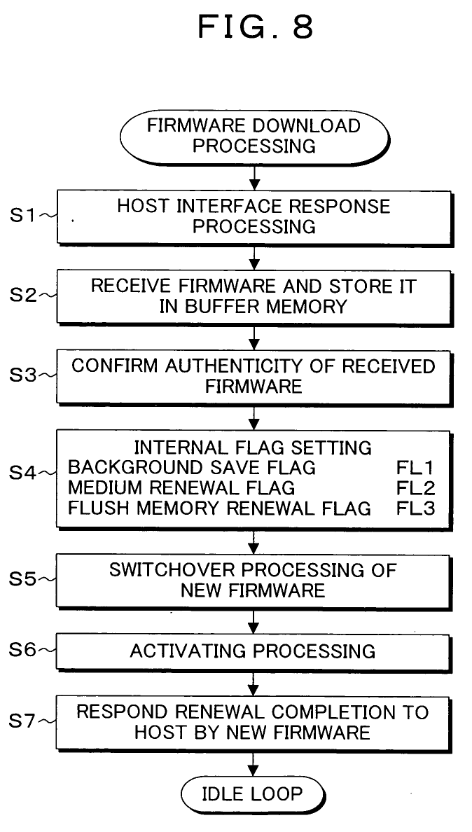

FIG. 8 is an explanatory drawing of the firmware download processing by the present embodiment, and shows a processing procedure by the renewal request processing unit 46 shown in the MPU26 of FIG. 1. In FIG. 8, at step S1, when the host interface control unit 34 receives a firmware renewal request command from the host, a host interface response processing is performed, so that the interface connection with the host is established. At step S2, the firmware transmitted from the host is received, and the new firmware is stored in the buffer memory 38 as shown in FIG. 4. Subsequently, at step S3, legality of the received new firmware stored in the buffer memory 38 is confirmed by checksum, and the like, and when the legality is confirmed, at step S4, an internal flag used for the processing of the background renewal unit 48 provided in the MPU 26 of FIG. 1 is set. The internal flag set in the present embodiment is a background save flag FL1, a medium renewal flag FL2, and a flush memory renewal flag FL3, and each of the Flags FL1, FL2 and FL3 is set to [1]. Next, at step S5, as shown in FIG. 4, the write processings 78-1 and 78-2 are performed, which overwrite the new firmware stored in the buffer memory 38 on the old firmware of the firmware area 72-2 of the direct access area 72-1 and the volatile memory 30 of the buffer memory 38, and by this overwriting, the old firmware is changed over to the new firmware. Subsequently, at step S6, by performing the activating processing as a power-on processing, the changed new firmware is executed. At step S7, by the new firmware, the host is advised of the renewal completion for the firmware renewal request, and a series of firmware download processing is completed. Then, the procedure proceeds to an idle loop.

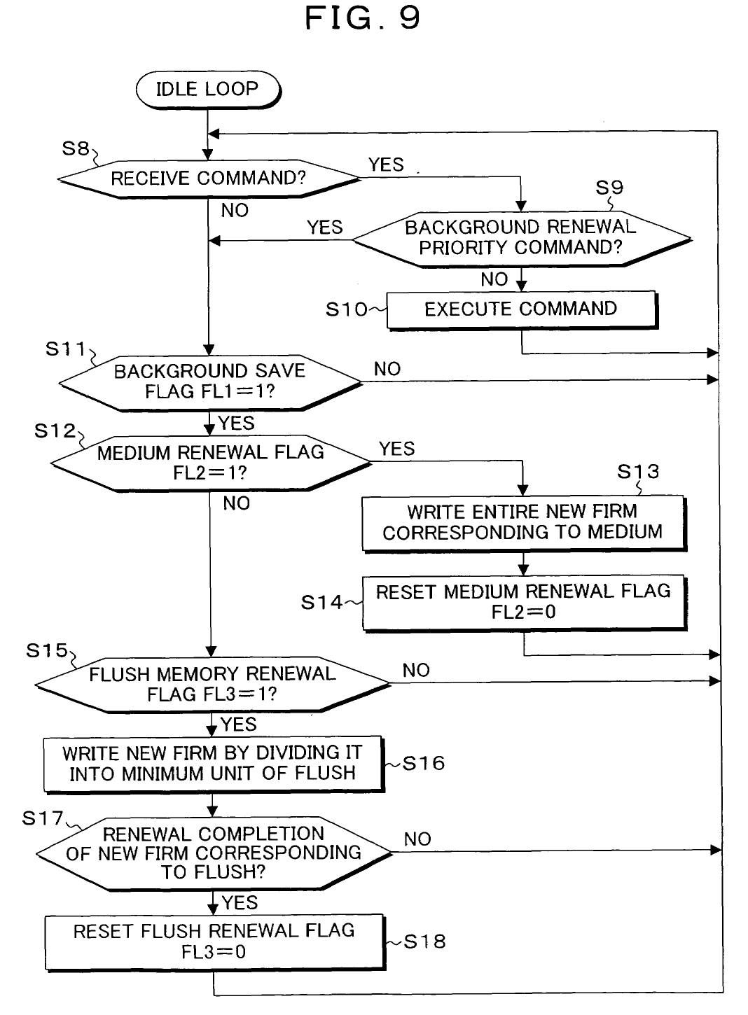

FIG. 9 is a flowchart of the firmware renewal processing to be executed as the background processing in the idle loop after the firmware download processing of FIG. 8 is completed, and shows a processing procedure by the background renewal unit 48 provided in the MPU 26 of FIG. 1.

In FIG. 9, at step S1, the presence or absence of the reception of the command generated inside the host or apparatus is checked, and when the command is received, the procedure proceeds to step S9 and checks whether it is a background renewal priority command. When it is a non-priority command for the background renewal such as the read command and the write command, the procedure proceeds to step S10, and executes the command. On the other hand, at step S9, when the command is a background renewal priority command such as a sequential access command, a status command, and the like, the procedure proceeds to step S11, and checks whether the background save flag FL1 is FL1=1. Here, since the background save flag FL1 is set to FL1=1 at step S4 in the firmware download processing of FIG. 8, the procedure proceeds to step S12, and checks whether the medium renewal flag FL2=1. Then, since the medium renewal flag FL2=1, the procedure proceeds to step S13, and as shown in FIG. 5, the new firmware portions corresponding to the magnetic disk 20-1 are collectively written and renewed in the firmware area 72-2 of the magnetic disk 20-1. Subsequently, at step S14, the medium renewal flag FL2 is reset so as to be FL2=0. Subsequently, the procedure returns to step S8, and checks the presence or absences of command reception, and if the command is received, proceeds to step S9, and if not received, proceeds to step S11, and because the background save flag FL1=1, proceeds to step S12. At this time, since the medium renewal flag FL2 is FL2=2, the procedure proceeds to step S15, and checks whether the flush memory renewal flag FL3 is FL3=1. Here, since FL3=1, the procedure proceeds to step 16, and divides the new firmware into the smallest access units of the flush ROM which is the non-volatile memory, and writes them as shown in FIG. 6. Subsequently, at step 17, the procedure checks whether the renewal of the new firmware for the non-volatile memory 32 which is the flush ROM is completed, and if not yet completed, the procedure repeats the processing from step S8 again. At step S17, when the procedure discriminates the renewal completion by the divided write of the new firmware on the non-volatile memory 32 using the flush ROM, at step 18, the procedure resets the flush memory renewal flag FL3 to FL3=0, and returns to step S8. Then, since the renewal is completed, the procedure returns to the ordinary command execution processings by steps S8, S9 and S10. Further, the present invention provides a program executed by the MPU 26 of FIG. 1, and this program is the contents shown in the flowcharts of FIG. 8 and 9. Further, the present invention provides a computer that stores the program executed by the firmware renewal processing of FIGS. 8 and 9 and a readable storage medium. This storage medium includes the storage medium and the like such as CD-ROM, a floppy disk (R), a DVD disk, a magnetic optical disk, an IC card, and a hard disk drive and the like provided inside and outside of the computer system in addition to a database to maintain a program through the circuit or a transmission medium on another computer system, the database, and the circuit. Incidentally, in the above described embodiment, as the system incorporating the magnetic disk device, though the disk array device of FIG. 2 has been taken as an example, the embodiment includes an appropriate system using a plurality of disk devices arranged under the command of a controller functioning as the hose device and adapted to the input and output processing. Needless to mention, the present invention is not limited to a plurality of magnetic disk devices arranged under the command of the host, but includes the storage apparatuses of the magnetic disk device and the optical disk device and the like used by the ordinary personal computer and the player. Further, in the above described embodiment, though the case has been taken as an example, where the firmware stored in the non-volatile memory and the magnetic disk such as the flush ROM is written and arranged in the buffer memory and the volatile memory so as to be executed, if the storage capacity of the volatile memory 30 is sufficient, the direct access area of the buffer memory 38 is not used, but in the volatile memory 30 only, the firmware may be written and arranged. Further, the present invention includes appropriate modifications not harming the object and advantages of the invention, and moreover, is not subjected to the limitation by the numerical values shown in the above described embodiment.

What is claimed is:

1. A storage apparatus, dividing and storing a firmware which is drive control software to record and reproduce data in the storage medium into a non-volatile memory and a storage medium, and storing and executing the firmware read from the non-volatile memory and storage medium in the volatile memory at the activating time of the apparatus, characterized by comprising:
a renewal request processing unit that advises a host device of the completion response at the time when a new firmware transmitted from the host device is received and stored in a buffer memory when the renewal request of the firmware is received from the host device; and
a background renewal unit that writes and renews the new firmware in the non-volatile memory and storage medium as a background processing using a processing idle time of the command issued by the host device after the advice of the renewal completion.

2. The storage apparatus according to claim 1, characterized in that the renewal request processing unit comprises:
a firmware changeover unit that overwrites the new firmware stored in the buffer memory on an old firmware developed in the buffer memory and the volatile memory, and after the renewal, activates the apparatus to change over to the processing of the new firmware; and
a response advising unit that advises the host device of the completion response for the renewal request by execution of the new firmware after the changeover.

3. The storage apparatus according to claim 1, characterized in that the background renewal unit overwrites and renews a first firmware portion corresponding to the disk medium from among the new firmware stored in the buffer memory and volatile memory on the old firmware portion of the storage medium as a whole, and divides a second firmware portion corresponding to the non-volatile memory from among the new firmware stored in the buffer memory and volatile memory into the smallest units writable in the non-volatile memory, and overwrites and renews them in order on the old firmware portion of the non-volatile memory.

4. The storage apparatus according to claim 1, characterized in that the background renewal unit prohibits
the control processing in which the generation of an idle time allotted with the renewal processing is inhibited during the renewal processing of the new firmware for the storage medium and the non-volatile memory.

5. The storage apparatus according to claim 1, characterized in that the background renewal unit, when received a command in which the generation of an idle time allotted with the renewal processing is inhibited during the renewal processing of the new firmware for the storage medium and the non-volatile memory, puts the execution of the command into a waiting state until the completion of the renewal processing, and allows the command to be executed when the renewal processing is completed.

6. The storage apparatus according to claim 1, characterized in that the background renewal unit puts the transmission of a status command into a waiting state until the completion of the renewal processing when received the status command advising the host device of the error or busy and the like during the renewal processing of the new firmware for the storage medium and non-volatile memory, and allows the transmission of the status command to be executed when the renewal processing is completed.

7. A firmware renewal method of the storage apparatus, dividing and storing the firmware which is drive control software to record and reproduce data in a storage medium into a non-volatile memory and the storage medium, and at the activating time of the apparatus, storing and executing the firmware read from the non-volatile memory and storage medium in the volatile memory, characterized by comprising:
a renewal request processing step that advises the host device of the completion response at the time when the new firmware transmitted from the host device is received and stored in the buffer memory when the renewal request of the firmware is received from the host device, and
a background renewal step that writes and renews the new firmware in the non-volatile memory and storage medium as a background processing using a processing idle time of the command issued by the host device after the advice of the renewal completion.

8. The firmware renewal method of the storage apparatus according to claim 7, characterized in that the renewal request processing step overwrites and renews the new firmware stored in the buffer memory on an old firmware developed in the buffer memory and volatile memory, and after that, activates the apparatus to change over to the processing of the new firmware; and advises the host device of the completion response for the renewal request by execution of the new firmware after the changeover.

9. The firmware renewal method of the storage apparatus according to claim 7, characterized in that the background renewal step overwrites and renews a first firmware portion corresponding to the disk medium from among the new firmware stored in the buffer memory and volatile memory on the old firmware portion of the storage medium as a whole, and divides a second firmware portion corresponding to the non-volatile memory from among the new firmware stored in the buffer memory and volatile memory into the smallest units writable in the non-volatile memory, and overwrites and renews them in order on the old firmware portion of the non-volatile memory.

10. The firmware renewal method of the storage apparatus according to claim 7, characterized in that the background renewal step prohibits the control processing in which the generation of an idle time allotted with the renewal processing is inhibited during the renewal processing of the new firmware for the storage medium and the non-volatile memory.

11. The firmware renewal method of the storage apparatus according to claim 7, characterized in that the background renewal step, when received a command in which the generation of an idle time allotted with the renewal processing is inhibited during the renewal processing of the new firmware for the storage medium and the non-volatile memory, puts the execution of the command into a waiting state until the completion of the renewal processing, and allows the command to be executed when the renewal processing is completed.

12. The firmware renewal method of the storage apparatus according to claim 7, characterized in that the background renewal step, when received the status command advising the host device of the error or busy and the like during the renewal processing of the new firmware for the storage medium and non-volatile memory, puts the transmission of a status command into a waiting state until the completion of the renewal processing and allows the status command to be executed when the renewal processing is completed.

13. A control device of the storage apparatus that divides and stores the firmware which is drive control software to record and reproduce data in a storage medium into a non-volatile memory and the storage medium, and at the activating time of the apparatus, stores and executes the firmware read from the non-volatile memory and storage medium in the volatile memory,
characterized by comprising:
a renewal request processing unit that advises the host device of the completion response at the time when the new firmware transmitted from the host device is received and stored in the buffer memory when the renewal request of the firmware is received from the host device, and
a background renewal unit that writes and renews the new firmware in the non-volatile memory and storage medium as a background processing using a processing idle time of the command issued by the host device after the advice of the renewal completion.

14. The control device of the storage apparatus according to claim 13, characterized in that the renewal request processing unit overwrites and renews the new firmware stored in the buffer memory on an old firmware developed in the buffer memory and volatile memory, and after that, activates the apparatus to change over to the processing of the new firmware; and advises the host device of the completion response for the renewal request by execution of the new firmware after the changeover.

15. The control device of the storage apparatus according to claim 13, characterized in that the background renewal unit overwrites and renews a first firmware portion corresponding to the disk medium from among the new firmware stored in the buffer memory and volatile memory on the old firmware portion of the storage medium as a whole, and divides a second firmware portion corresponding to the non-volatile memory from among the new firmware stored in the buffer memory and volatile memory into the smallest units writable in the non-volatile memory, and overwrites and renews them in order on the old firmware portion of the non-volatile memory.

16. The control device of the storage apparatus according to claim 1, characterized in that the background renewal unit prohibits the control processing in which the generation of an idle time allotted with the renewal processing is inhibited during the renewal processing of the new firmware for the storage medium and the non-volatile memory.

17. The control device of the storage apparatus according to claim 13, characterized in that the background renewal unit, when received a command in which the generation of an idle time allotted with the renewal processing is inhibited during the renewal processing of the new firmware for the storage medium and the non-volatile memory, puts the execution of the command into a waiting state until the completion of the renewal processing, and allows the command to be executed when the renewal processing is completed.

18. The control device of the storage apparatus according to claim 13, characterized in that the background renewal unit, when received the status command advising the host device of the error or busy and the like during the renewal processing of the new firmware for the storage medium and non-volatile memory, puts the transmission of the status command into a waiting state until the completion of the renewal processing and allows the transmission of the status command to be executed when the renewal processing is completed.
